(19) United States
(12) Patent Application Publication
(10) Pub. No.: US 2016/0277834 A1
(43) Pub. Date: Sep. 22, 2016

(54) Sound Masking Apparatus and Sound Masking Method

(71) Applicant: Yamaha Corporation, Hamamatsu-shi (JP)

(72) Inventors: Masato HATA, Hamamatsu-shi (JP); Takashi YAMAKAWA, Iwata-shi (JP)

(21) Appl. No.: 15/074,002

(22) Filed: Mar. 18, 2016

(30) Foreign Application Priority Data
Mar. 20, 2015 (JP) 2015-058735

(51) Int. Cl. H04R 3/04; H04R 29/00; G10K 11/175

(52) U.S. Cl. CPC H04R 3/04; G10K 11/175; H04R 29/00

(57) ABSTRACT

A sound masking apparatus includes a reproduction processor configured to detect periodicity in a masker sound and add a delay to the masker sound in accordance with a detection result of the periodicity. The sound masking apparatus can prevent an unbalanced sound pressure distribution of masker sounds within an acoustic space without causing discomfort to a listener.

### CROSS REFERENCE TO RELATED APPLICATIONS

This application is based on Japanese Patent Application (No. 2015-058735) filed on Mar. 20, 2015, the contents of which are incorporated herein by reference.

### BACKGROUND OF THE INVENTION

1. Field of the Invention

The present disclosure relates to a technique for preventing overhearing of a sound by utilizing a masking effect.

2. Description of the Related Art

As used herein, the term “masking effect” refers to a phenomenon in which a normally clearly audible sound is masked with another sound and thus made inaudible. An exemplary technique for preventing overhearing of a sound by utilizing a masking effect is the use of a sound masking apparatus. A sound masking apparatus emits a masker sound into an acoustic space, thus making it difficult for a third party to hear a sound made by a particular speaker or a conversation between particular speakers within the acoustic space. Specific examples of masker sounds include: a disturbing sound; a non-disturbing sound, such as an environmental sound; and a mixture of disturbing and non-disturbing sounds. As used herein, the term “disturbing sound” refers to a sound that is made meaningless or unintelligible by scrambling a human voice. A disturbing sound advantageously has a high masking effect, but may disadvantageously cause discomfort to a listener. As used herein, the term “environmental sound” refers to a sound heard commonly in nature, such as a forest sound (e.g., bird song, or a tree rustling sound) or a wave sound. A non-disturbing sound, such as an environmental sound, advantageously contributes to stage effects within a space, but disadvantageously has a lower masking effect than a disturbing sound. A mixture of disturbing and non-disturbing sounds is used as a masker sound in order to obtain the advantages of both of the disturbing and non-disturbing sounds.

When a sound masking apparatus is to be installed in an acoustic space, a mode of installation of the apparatus has to be determined in consideration of the size or extent of the acoustic space in which the apparatus is to be installed. For example, sound masking apparatuses to be installed in a relatively large space, such as a hotel lobby, are preferably to be installed at the four corners of a ceiling so as to resonate masker sounds throughout the space. When a four-channel output sound masking apparatus is to be installed in such a relatively large space, four speakers of the apparatus may be disposed at the four corners of the ceiling.

The above-mentioned installation modes, however, have problems described below. Masker sounds emitted from a plurality of speakers disposed within the same space (or room) usually interfere with each other. This interference results in differences between sound pressures of the masker sounds in accordance with distances between the speakers and locations at which the masker sounds are measured. In particular, when masker sounds having the same phase are emitted from the speakers, the masker sound measured at a location equidistant from the speakers (e.g., a location at the center or its vicinity of the room) has a higher sound pressure level than the masker sound measured in an area surrounding this location. This leads to an unbalanced sound pressure distribution of the masker sounds within the space. The above-mentioned interference may also degrade frequency characteristics of the masker sounds resonated in the space.

An unbalanced sound pressure distribution of masker sounds, which occurs as mentioned above, causes masking effect variations responsive to distances from the speakers. Such an unbalanced sound pressure distribution of masker sounds may reduce the spread of masker sounds, or resonance of masker sounds throughout the space, resulting in auditory unpleasantness of a listener. Furthermore, masker sounds having degraded frequency characteristics may become unpleasant sounds, causing discomfort to the listener. Known solutions to these problems include a technique for preventing an unbalanced sound pressure distribution of masker sounds by reducing or eliminating the correlation between the masker sounds to be emitted from a plurality of speakers.

For example, a masker sound output apparatus disclosed in JP-A-2012-137742 stores sound data of a disturbing sound (which is described as a background sound in JP-A-2012-137742) and an environmental sound (which is described as a stage effect sound in JP-A-2012-137742) each having a predetermined wavelength. The masker sound output apparatus repeats the process of mixing the sound data of the disturbing sound with the sound data of the environmental sound, and the process of emitting the resulting sound as a masker sound. When a plurality of the masker sound output apparatuses are disposed in an acoustic space to carry out masking, the timing of start of masker sound reproduction is randomly changed for each of the masker sound output apparatuses, thus preventing an unbalanced sound pressure distribution of masker sounds.

However, the use of the masker sound output apparatus to emit a wave sound or a forest sound as an environmental sound, for example, presents problems described below. A periodic sound, such as the wave sound, has a sound pressure level varying during a certain period. When the timing of start of wave sound reproduction is randomly changed for each of the masker sound output apparatuses, the timing of sound pressure level peaks of wave sounds changes, so that the original periodicity of the wave sounds is lost, resulting in unpleasant sounds. When a non-periodic sound, such as the forest sound, is emitted at a randomly-set timing, unfavorable reverberation of the forest sound occurs within a space depending on the timing, which means that an unpleasant sound resonates and causes discomfort to a listener. The same goes for a disturbing sound.

### SUMMARY OF THE INVENTION

The present disclosure has been made in view of the above-described circumstances, and its object is to provide a technique for preventing an unbalanced sound pressure distribution of masker sounds within an acoustic space without causing discomfort to a listener.

A sound masking apparatus according to one aspect of the present disclosure includes a reproduction processor configured to detect periodicity in a masker sound and add a delay to the masker sound in accordance with a detection result of the periodicity.

### BRIEF DESCRIPTION OF THE DRAWINGS

FIG. 1 is a block diagram illustrating a configuration of a sound masking apparatus 1 according to an embodiment of the present disclosure.

FIGS. 2A and 2B are graphs each illustrating sound pressure distributions of masker sounds emitted from the sound masking apparatus 1 according to the present embodiment.

FIGS. 3A and 3B each illustrate an exemplary waveform of an environmental sound to which no delay is added, and an exemplary waveform of an environmental sound to which a delay is added.

FIGS. 4A and 4B each illustrate results of subjective estimation of discomfort perceived by a listener of masker sounds emitted from the sound masking apparatus 1 according to the present embodiment.

### DETAILED DESCRIPTION OF THE EXEMPLARY EMBODIMENTS

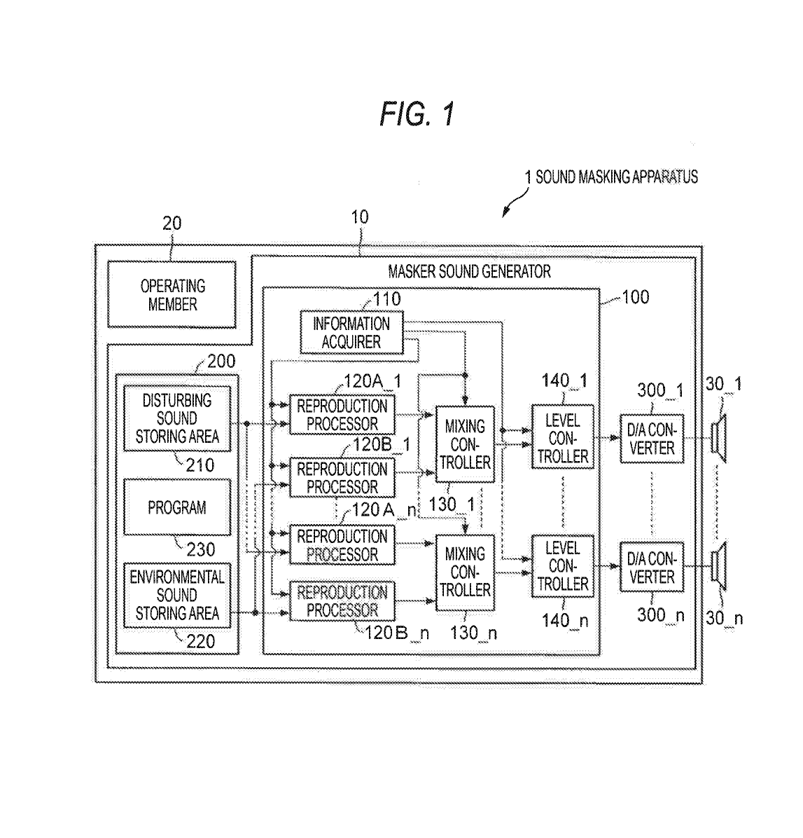

FIG. 1 is a block diagram illustrating a configuration of a sound masking apparatus 1 according to an embodiment of the present disclosure. The sound masking apparatus 1 is installed in a hotel lobby, for example. The sound masking apparatus 1 emits masker sounds from N output systems. Note that although N may be any natural number, N=4 in the present embodiment. In the present embodiment, a mixture of a disturbing sound and a non-disturbing sound is used as a masker sound, and an environmental sound is used as a non-disturbing sound. As illustrated in FIG. 1, the sound masking apparatus 1 includes a masker sound generator 10, an operating member 20, and speakers 30_1 to 30_n (n=2 to N) functioning as the N output systems. Because N=4 in the present embodiment, the speakers 30_1 to 30_n may also be referred to as the “speakers 30_1 to 304”.

The operating member 20 and the speakers 30_1 to 30_n are similar to those used in a conventional sound masking apparatus, and will be briefly described as follows. The operating member 20 allows a user to input various pieces of information. The operating member 20 includes a push button, a volume knob, and/or a touch panel provided on a casing of the sound masking apparatus 1. The user operates the operating member 20 to select the type of non-disturbing sound to be included in a masker sound, and/or to specify the mixing ratio between disturbing and non-disturbing sounds, for example. Any operation performed on the operating member 20 prompts the operating member 20 to provide information responsive to the operation to the masker sound generator 10. The speakers 30_1 to 30_n each receive a masker sound signal from the masker sound generator 10 and emit the signal in the form of a masker sound. In the present embodiment, the speakers 30_1 to 30_4 are each disposed on the ceiling of the hotel lobby so that the speakers 30_1 to 30_4 are equidistant from the intersection of diagonal lines each connecting the associated ones of the speakers 30_1 to 30_4.

The masker sound generator 10 generates and outputs a masker sound signal in accordance with the information received from the operating member 20. The masker sound generator 10 includes a CPU 100, a storage 200, and D/A converters 300_1 to 300_n. The storage 200 is a read-only memory (ROM), for example. The storage 200 includes a disturbing sound storing area 210 and an environmental sound storing area 220. The storage 200 stores a program 230 to be executed by the CPU 100.

The disturbing sound storing area 210 stores disturbing sound data. The disturbing sound data is a sample data sequence of disturbing sounds for a predetermined time period. As used herein, the term “disturbing sound data” refers to waveform data of a sound obtained by making a human voice meaningless or unintelligible, for example. Specifically, human voices are collected to generate waveform data, the waveform data is divided into a plurality of frames, and these frames are rearranged in a sequence different from that in which frames of original sounds are arranged, thus generating disturbing sound data.

The environmental sound storing area 220 stores environmental sound data. The environmental sound data is a sample data sequence of environmental sounds for a predetermined time period. In the present embodiment, waveform data of four types of sounds in the form of environmental sound data is stored in advance in the environmental sound storing area 220. The four types of sounds are: forest sounds (e.g., bird song, and tree rustling sounds); wave sounds; urban crowd sounds (e.g., everyday sounds heard in the city); and air-conditioning sounds. In addition to the four types of sounds, sounds of the hotel lobby, for example, may naturally be stored in the environmental sound storing area 220 when necessary.

The CPU 100 executes the program 230 stored in the storage 200, and thus fulfills a pivotal role in controlling the components of the masker sound generator 10. As illustrated in FIG. 1, functions implemented by execution of the program 230 by the CPU 100 include: an information acquirer 110; reproduction processors 120A_1 to 120A_n (n=2 to N); reproduction processors 120B_1 to 120B_n (n=2 to N); mixing controllers 130_1 to 130_n (n=2 to N); and level controllers 140_1 to 140_n (n=2 to N).

The information acquirer 110 acquires various pieces of information input by operation of the operating member 20. More specifically, the information acquirer 110 operates as follows. The user selects an environmental sound type by operating the operating member 20. In response to this, the information acquirer 110 provides, to each of the reproduction processors 120B_1 to 120B_n, an instruction for reading environmental sound data corresponding to the environmental sound type selected by the user. This reading instruction includes information indicative of the environmental sound type selected. In response to the selecting operation, the information acquirer 110 also provides a disturbing sound data reading instruction to each of the reproduction processors 120A_1 to 120A_n. The user sets a mixing ratio between the disturbing and environmental sounds by operating the operating member 20. In response to this, the information acquirer 110 provides a mixing control instruction to each of the mixing controllers 130_1 to 130_n. The mixing control instruction is provided to exercise control over mixing of disturbing sound data and environmental sound data. The mixing control instruction includes information indicative of the mixing ratio. The user sets a masker sound volume by operating the operating member 20. In response to this, the information acquirer 110 provides a level control instruction to each of the level controllers 140_1 to 140_n. The level control instruction is provided to execute a level control process (which will be described below). The level control instruction includes information indicative of the masker sound volume.

The reproduction processors 120A_1 to 120A_n each detect the presence or absence of periodicity in a masker sound to be emitted, or more specifically, a disturbing sound to be included in the masker sound, and add a delay responsive to the detection result to the disturbing sound. The reproduction processors 120B_1 to 120B_n each detect the presence or absence of periodicity in a masker sound to be emitted, or more specifically, a non-disturbing sound to be included in the masker sound, and add a delay responsive to the detection result to the non-disturbing sound. Upon receiving the reading instruction from the information acquirer 110, the reproduction processors 120A_1 to 120A_n each read (or acquire) disturbing sound data from the disturbing sound storing area 210, and repeat the process of sequentially outputting samples included in the disturbing sound data to the associated one of the mixing controllers 130_1 to 130_n until receiving a masker sound reproduction stopping instruction. Such a process will hereinafter be referred to as “reproducing”. The reproduction processors 120B_1 and 120B_n each read (or acquire), from the environmental sound storing area 220, environmental sound data specified by the reading instruction from the information acquirer 110, and reproduce the environmental sound data.

As already described, to prevent an unbalanced sound pressure distribution of masker sounds to be emitted into a space, the timing of start of masker sound emission (or the phase of a masker sound of each of N channels emitted from the speakers) has to be different for each channel. As used herein, the term “channel” refers to an output system. To achieve such different timing, in reading disturbing sound data, the reproduction processors 120A_1 to 120A_n (n=2 to N) according to the present embodiment start reading sample data at different times for the associated channels, and in reading environmental sound data, the reproduction processors 120B_1 to 120B_n (n=2 to N) according to the present embodiment start reading sample data at different times for the associated channels. More specifically, upon receiving the reading instruction, the reproduction processor 120A_1 starts reading disturbing sound data from first sample data. Upon receiving the reading instruction, the reproduction processor 120A_2 starts reading the disturbing sound data from sample data at a time t second(s) after the first sample data. Upon receiving the reading instruction, the reproduction processor 120A_3 starts reading the disturbing sound data from sample data at a time 2×t second(s) after the first sample data. Upon receiving the reading instruction, the reproduction processor 120A_n starts reading the disturbing sound data from sample data at a time t×(n−1) second(s) after the first sample data. Therefore, if the t second(s) is regarded as a reference delay time, each of delays among the analog masker sounds output from the speakers 30_1 to 30_n is an integral multiple of the reference delay time. The reproduction processors 120B_1 to 120B_n perform processes similar to those just described.

Accordingly, the disturbing sound data reproduced by the reproduction processor 120A_n (n=2 to N) is delayed by t second(s) with respect to the disturbing sound data reproduced by the reproduction processor 120A_n−1. Thus, delays are added to disturbing sounds of the N channels to be output from the speakers in the present embodiment. The same processes are applied to environmental sound data. Consequently, delays in increments of t second(s) are added to disturbing sounds and environmental sounds of the channels to be output from the speakers. Masker sounds of the channels to be output from the speakers have phase differences responsive to the delays in increments of t second(s). This reduces the correlation between the masker sounds of the channels to be emitted from the speakers, and prevents an unbalanced sound pressure distribution of the masker sounds in the space. Thus, the present embodiment eliminates or reduces variations in masking effect, and precludes a situation where the listener feels auditory unpleasantness due to an insufficient spread of the masker sounds. Furthermore, the present embodiment eliminates or reduces degradation in the frequency characteristics of the masker sounds resonating throughout the room, thus preventing the listener from hearing unpleasant sounds.

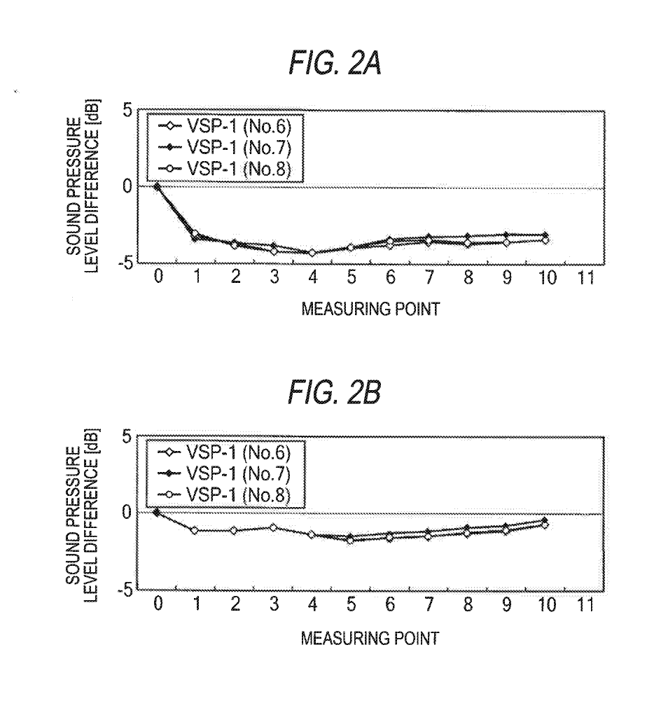

FIGS. 2A and 2B are graphs each illustrating results of measurement of sound pressure distributions of masker sounds. In the measurement, masker sounds were emitted from the four speakers of the sound masking apparatus 1 disposed equidistantly on a ceiling, and the inventors measured sound pressure levels of the masker sounds at measuring points across a region between the position directly below one of the speakers and the center of a room. FIG. 2A illustrates the sound pressure distributions of the masker sounds to which no delay is added. FIG. 2B illustrates the sound pressure distributions of the masker sounds to which delays are added. The horizontal axis in each of FIGS. 2A and 2B represents the measuring points. The measuring point indicated by the minimum value “0” is located at the center of the room, and the measuring point indicated by the maximum value “10” represents the position directly below one of the speakers. The vertical axis in each of FIGS. 2A and 2B represents the sound pressure levels at the measuring points relative to the sound pressure level at the center of the room, i.e., differences between the sound pressure levels at the measuring points and the sound pressure level at the center of the room. In FIGS. 2A and 2B, VSP-1 (No. 6) to VSP-1 (No. 8) each represent an identifier indicative of the type of masker sound. VSP-1 (No. 6) represents an identifier indicative of a masker sound including a disturbing sound and an urban crowd sound that is an environmental sound. VSP-1 (No. 7) represents an identifier indicative of a masker sound including a disturbing sound and a hotel lobby sound that is an environmental sound. VSP-1 (No. 8) represents an identifier indicative of a masker sound including a disturbing sound and an air-conditioning sound that is an environmental sound. With no delay added to the masker sounds, the sound pressure level differences reach about 4 dB irrespective of the type of masker sound, as illustrated in FIG. 2A. In contrast, with delays added to the masker sounds, the sound pressure level differences fall within 2 dB irrespective of the type of masker sound, as illustrated in FIG. 2B. Thus, the sound pressure level differences are reduced by one-half by adding delays to the masker sounds.

As already mentioned, if masker sounds of the channels each having different phase to each other are emitted from the speakers, the phase differences (or emission start timing) must be adjusted to appropriate values in accordance with the type of disturbing sound or environmental sound in order to prevent emission of unpleasant sounds. To prevent emission of unpleasant sounds, the reproduction processors 120A_1 to 120A_n and 120B_1 to 120B_n carry out processes that are significant features of the present disclosure. The processes carried out by the reproduction processors 120B_1 to 120B_n will be described in detail below. Upon reading environmental sound data from the environmental sound storing area 220, the reproduction processors 120B_1 to 120B_n each detect whether the environmental sound data has periodicity. The presence or absence of periodicity may be detected using a known method, such as autocorrelation calculation, for example. A periodic environmental sound (, that is, a sound having a variable sound pressure level) will hereinafter be referred to as a “non-steady sound”. A non-periodic environmental sound (, that is, a sound having a constant sound pressure level) will hereinafter be referred to as a “steady sound”. Examples of the non-steady sound include a wave sound. Examples of the steady sound include a forest sound.

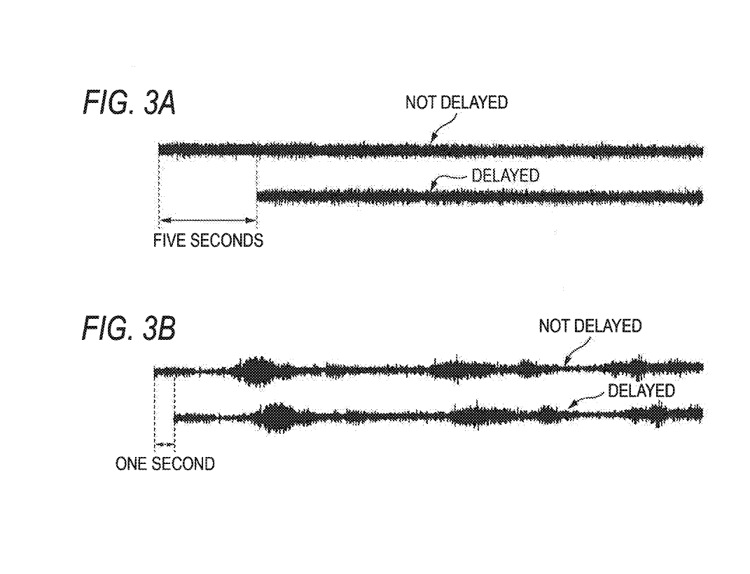

Following the detection process, the reproduction processors 120B_1 to 120B_n each decide the value of the delay t in accordance with the detection result. FIGS. 3A and 3B each illustrate an exemplary waveform of an environmental sound to which no delay is added, and an exemplary waveform of an environmental sound to which a delay is added. FIG. 3A illustrates the waveform of a steady sound to which no delay is added, and the waveform of a steady sound to which a delay is added. As illustrated in FIG. 3A, upon detecting that the environmental sound data acquired is a sample data sequence of a steady sound, i.e., upon detecting that the environmental sound has no periodicity, the reproduction processors 120B_1 to 120B_n each decide the value of the delay t so that t=5. FIG. 3B illustrates the waveform of a non-steady sound to which no delay is added, and the waveform of a non-steady sound to which a delay is added. As illustrated in FIG. 3B, upon detecting that the environmental sound data acquired is a sample data sequence of a non-steady sound, the reproduction processors 120B_1 to 120B_n each decide the value of the delay t so that t=1. Thus, a delay of five seconds is added to the steady sound, and a delay of one second is added to the non-steady sound. The reason why a delay added to a steady sound differs from a delay added to a non-steady sound is as follows. Suppose that a non-steady sound to which no delay is added and a non-steady sound to which a delay is added are emitted into a space. In that case, an excessively long delay causes loss of periodicity in the non-steady sounds overlapping with each other. To prevent such loss of periodicity, as illustrated in FIG. 3B, the delay (i.e., the value of t) is set to be equal to a time length during which the peak of sound waveform of the delayed non-steady sound and the peak of sound waveform of the non-delayed non-steady sound partially overlap with each other. In the example illustrated in FIG. 3B, the delay is one second. As used herein, the term “peak” refers to a portion of a sound waveform envelope having a higher local relative sound pressure level than the other portions. A portion corresponding to a peak may be determined by comparing the sound pressure level of a non-steady sound with any threshold value. As illustrated in FIG. 3A, for steady sounds, the above-described phenomenon, i.e., loss of periodicity, does not occur irrespective of the value of the delay, because steady sounds have no periodicity. Steady sounds, however, will create an echo-like auditory effect if a delay to be added is extremely short. To prevent such an unfavorable effect, the reproduction processors 120B_1 to 120B_n each add, to a steady sound, a delay longer than that to be added to a non-steady sound. Note that an increase in the number of channels increases the width of the overlapping portion accordingly, resulting in loss of periodicity. To prevent such loss of periodicity, the width of the overlapping portion has to be limited. For example, the width of the overlapping portion may be limited by reducing the number of channels, or changing the delay without changing the number of channels. In the former example, when masker sounds are emitted from four locations on the ceiling of a room, for example, two two-channel sound masking apparatuses 1 may be used instead of the four-channel sound masking apparatus 1. In that case, the speakers of each sound masking apparatus 1 corresponding to the different channels have to be arranged on the diagonal line. This arrangement eliminates the correlation between the masker sounds, thus achieving effects similar to those obtained when the four-channel sound masking apparatus 1 is used. In the latter example, the four-channel sound masking apparatus 1, for example, may be configured so that a delay of t×(n−1) seconds (where t=1, and n=3) is added to non-steady sounds to be emitted from a plurality of channels (e.g., three or four channels). Thus, the width of the overlapping portion is reduced to a width similar to that obtained when a three-channel sound masking apparatus is used.

The reproduction processors 120A_1 to 120A_n each invariably decide the value of the delay t so that t=5. This is because a disturbing sound usually has no periodicity and is thus regarded as being similar to a steady sound in terms of periodicity. Alternatively, the presence or absence of periodicity may also be detected for a disturbing sound, and a delay responsive to the detection result may be added to the disturbing sound. For example, a long delay may be added to a non-periodic disturbing sound, and a short delay may be added to a periodic disturbing sound.

The mixing controllers 130_1 to 130_n mix sound data output from the reproduction processors 120A_1 to 120A_n with sound data output from the reproduction processors 120B_1 to 120B_n. More specifically, the mixing controllers 130_1 to 130_n mix disturbing sound data output from the reproduction processors 120A_1 to 120A_n with environmental sound data output from the reproduction processors 120B_1 to 120B_n. The mixing controllers 130_1 to 130_n each mix the disturbing sound data output from the associated one of the reproduction processors 120A_1 to 120A_n with the environmental sound data output from the associated one of the reproduction processors 120B_1 to 120B_n in accordance with the mixing ratio specified by the mixing control instruction received from the information acquirer 110. The mixing controllers 130_1 to 130_n each provide the resulting data in the form of masker sound data to the associated one of the level controllers 140_1 to 140_n.

The level controllers 140_1 to 140_n each amplify the masker sound data received from the associated one of the mixing controllers 130_1 to 130_n such that the level of the masker sound data is equal to the volume specified by the level control instruction received from the information acquirer 110. The level controllers 140_1 to 140_n each output the amplified masker sound data to the associated one of the D/A converters 3001 to 300_n.

The D/A converters 300_1 to 300_n each convert the masker sound data, which has been received from the associated one of the level controllers 140_1 to 140_n, from a digital masker sound signal into an analog masker sound signal, and output the analog masker sound signal to the associated one of the speakers 30_1 to 30_n. The speakers 30_1 to 30_n each receive the masker sound signal from the associated one of the D/A converters 300_1 to 300_n, and emit the masker sound signal in the form of a masker sound.

What has been described thus far is the configuration of the sound masking apparatus 1.

Operations performed by the sound masking apparatus 1 will now be described on the assumption that a forest sound is selected as an environmental sound during the morning and a wave sound is selected as an environmental sound during the afternoon. For example, when the user who comes to work during working hours selects a forest sound by operating the operating member 20, the information acquirer 110 provides a reading instruction including information indicative of the forest sound to each of the reproduction processors 120B_1 to 120B_n. Upon receiving the reading instruction, the reproduction processors 120B_1 to 120B_n each read environmental sound data corresponding to the forest sound from the environmental sound storing area 220 of the storage 200, and detect the presence or absence of periodicity in the environmental sound data. Because the forest sound is a steady sound, the reproduction processors 120B_1 to 120B_n each detect that the environmental sound data has no periodicity, and start reproducing the environmental sound data, with the delay set so that t=5. Thus, masker sounds including the forest sounds having phase differences each responsive to a delay of five seconds for every channels are emitted from the speakers into a hotel lobby during the morning.

In the afternoon, the user changes the type of environmental sound to a wave sound. In response to this change, the information acquirer 110 provides a reading instruction including information indicative of the wave sound to each of the reproduction processors 120B_1 to 120B_n. Upon receiving the reading instruction, the reproduction processors 120B_1 to 120B_n each read environmental sound data corresponding to the wave sound from the environmental sound storing area 220 of the storage 200, and detect the presence or absence of periodicity in the environmental sound data. Because the wave sound is a non-steady sound, the reproduction processors 120B_1 to 120B_n each detect that the environmental sound data has periodicity, and start reproducing the environmental sound data, with the delay set so that t=1. Thus, masker sounds including the wave sounds having phase differences each responsive to a delay of one second for every channels are emitted from the speakers into the hotel lobby during the afternoon.

Thus, when the user changes the type of environmental sound from a forest sound, which is a steady sound, to a wave sound, which is a non-steady sound, the reproduction processors 120B_1 to 120B_n change the delays of masker sounds of the channels to be output from the speakers from five seconds to one second. In contrast, when the user changes the type of environmental sound from a wave sound, which is a non-steady sound, to a forest sound, which is a steady sound, the reproduction processors 120B_1 to 120B_n change the delays of masker sounds of the channels to be output from the speakers from one second to five seconds. No matter what type of environmental sound is selected by the user, the reproduction processors 120B_1 to 120B_n each detect the presence or absence of periodicity in an environmental sound every time the environmental sound is selected, and add a delay responsive to the detection result to the environmental sound. In other words, the present embodiment eliminates the need for the user to adjust the delay in accordance with the type of environmental sound.

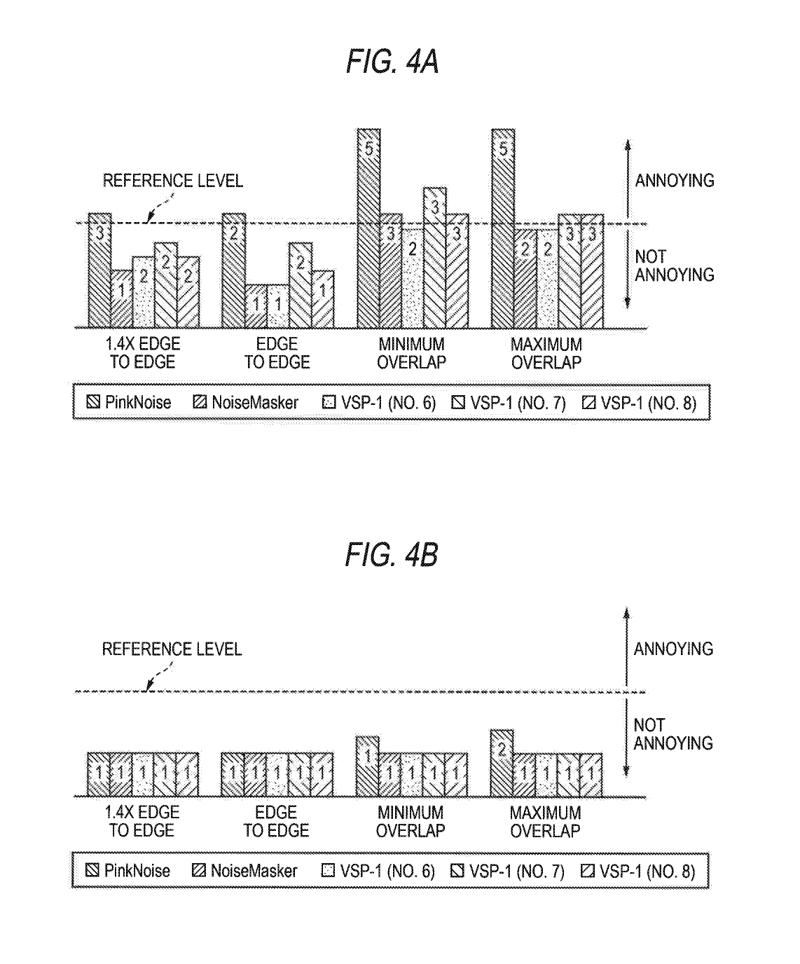

FIGS. 4A and 4B each illustrate results of subjective estimation of discomfort perceived by a masker sound listener. In the estimation, the inventors numerically expressed, in the form of subjective estimation values, auditory impressions perceived by the listener of masker sounds emitted from the speakers, with the locations of the speakers of the sound masking apparatus 1 on the ceiling of a room changed in various ways. The volume of the masker sounds reproduced was 45 dBA. FIG. 4A illustrates the results of the estimation obtained for the masker sounds to which no delay is added. FIG. 4B illustrates the results of the estimation obtained for the masker sounds to which delays are added in accordance with the presence or absence of periodicity. In FIGS. 4A and 4B, “Pink Noise”, “Noise Masker”, and “VSP-1 (No. 6)” to “VSP-1 (No. 8)” each represent an identifier indicative of the type of masker sound. “Pink Noise” represents an identifier indicative of noise whose energy is constant for each octave. “Noise Masker” represents an identifier indicative of a masker sound including a pseudo air-conditioning sound. “VSP-1 (No. 6)” to “VSP-1 (No. 8)” each represent an identifier indicative of the type of masker sound as described with reference to FIGS. 2A and 2B. In carrying out the estimation, the reproduction processors 120A_1 to 120A_n and 120B_1 to 120B_n performed the above-described processes; as a result, a delay of 5×(n−1) seconds was added to disturbing sounds and steady sounds, and a delay of n−1 second(s) was added to non-steady sounds. In each of FIGS. 4A and 4B, the vertical axis represents the subjective estimation values. The auditory impression perceived by the listener is determined to be “not annoying” when the subjective estimation value is at or below a reference level, and is determined to be “annoying” when the subjective estimation value is above the reference level. In each of FIGS. 4A and 4B, the horizontal axis represents the speaker locations. More specifically, “MAXIMUM OVERLAP” represents speaker locations that cause the sound pressure contour (or sound pressure level contour) of one of the speakers to pass through the center of the sound pressure contour of the adjacent speaker. “MINIMUM OVERLAP” represents speaker locations that cause the sound pressure contour of each speaker to pass through the point corresponding to the center (or center of gravity) of each target speaker. “EDGE TO EDGE” represents speaker locations that cause the sound pressure contours of the speakers to come into contact with each other without overlapping with each other. “1.4× EDGE TO EDGE” represents speaker locations that cause the sound pressure contours of the speakers to come into contact with each other, with the intervals between the centers of the sound pressure contours being 1.4 times greater than those for “EDGE TO EDGE”. Comparisons between the results in FIGS. 4A and 4B indicate that, irrespective of the speaker locations or the type of masker sound, the subjective estimation values obtained when delays are added are all below the reference level, and more favorable than those obtained when no delay is added.

The sound masking apparatus 1 according to the present embodiment allows masker sounds of channels emitted from the speakers to have phase differences responsive to the delays, thus preventing an unbalanced sound pressure distribution of the masker sounds within an acoustic space. In addition, the sound masking apparatus 1 adds the delays to the masker sounds in accordance with the type of the masker sounds, thus preventing discomfort to the listener.

Variations

Although the embodiment of the present disclosure has been described above, the present disclosure includes variations described below.

First Variation

In the above embodiment, the reproduction processor 120A_n (n=2 to N) starts reading disturbing sound data from sample data at the time t×(n−1) second(s) after the first sample data, and the reproduction processor 120B_n (n=2 to N) starts reading environmental sound data from sample data at the time t×(n−1) second(s) after the first sample data. Alternatively, the reproduction processor 120A_n (n=2 to N) may start reading disturbing sound data at a different time, and the reproduction processor 120B_n (n=2 to N) may start reading environmental sound data at a different time. More specifically, the reproduction processor 120A_2 may start reading disturbing sound data at a time t second(s) (t=5 or 1) after the reproduction processor 120A_1 has started reading disturbing sound data, the reproduction processor 120A_3 may start reading disturbing sound data at a time t second(s) (t=5 or 1) after the reproduction processor 120A_2 has started reading disturbing sound data, and the reproduction processor 120A_n may start reading disturbing sound data at a time t second(s) (t=5 or 1) after the reproduction processor 120A_n−1 has started reading disturbing sound data. The reproduction processors 120B_2, 120B_3, and 120B_n may start reading environmental sound data in a manner similar to that just described. Also in this variation, delays in increments of t second(s) are added to masker sounds of channels to be emitted from the speakers.

Second Variation

In the above embodiment, the reproduction processors 120A_1 to 120A_2 and 120B_1 to 120B_n each add a delay of five seconds to a steady sound and a delay of one second to a non-steady sound. Alternatively, a delay to be added to a steady sound and a delay to be added to a non-steady sound may each be any suitable length of time. For example, when necessary, the reproduction processors 120B_1 to 120B_n may each adjust the time length of a delay to be added to a non-steady sound in accordance with the period of periodicity of the non-steady sound. This adjustment makes it possible to add a delay to an environmental sound in accordance with not only the presence or absence of periodicity but also the period of periodicity. As a result, the auditory impression of the listener will be more favorable. The time lengths of delays to be added may also be adjusted in consideration of the frequency characteristics of an environmental sound. Thus, the stage effect of the environmental sound resonating within a space is enhanced.

Third Variation

In the above embodiment, the reproduction processors 120A_1 to 120A_n analyze disturbing sound data, and the reproduction processors 120B_1 to 120B_n analyze environmental sound data, for detecting the presence or absence of periodicity. Alternatively, information indicative of the presence or absence of periodicity may be associated with information indicative of the types of disturbing sound and environmental sound, and the resulting information may be stored in advance in a table. This allows the reproduction processors 120A_1 to 120A_n to detect the presence or absence of periodicity in disturbing sounds by making reference to the information stored in the table, and allows the reproduction processors 120B_1 to 120B_n to detect the presence or absence of periodicity in environmental sounds by making reference to the information stored in the table. Consequently, a reduction in processing load is enabled.

Fourth Variation

In the above embodiment, the user selects the type of environmental sound by operating the operating member 20. Alternatively, the type of environmental sound may be automatically changed in accordance with the time of day. In another alternative, the sound masking apparatus 1 may be provided with a microphone, and the type of environmental sound may be automatically changed in accordance with acoustic characteristics of sounds picked up by the microphone.

Fifth Variation

In the above embodiment, disturbing sound data and environmental sound data are respectively stored in advance in the disturbing sound storing area 210 and the environmental sound storing area 220. Alternatively, disturbing sound data and environmental sound data may be downloaded over a network. In another alternative, data of masker sounds may be acquired in real time through a microphone.

Sixth Variation

The information acquirer 110 according to the above embodiment acquires various pieces of information, including the type of environmental sound, through the operating member 20. Alternatively, such information may be acquired from an external source, such as an external server, through a communication device, for example, without the use of the operating member 20. Thus, various instructions are provided to the sound masking apparatus 1 from, for example, a central control room, resulting in an enhancement in convenience.

Seventh Variation

The above embodiment has been described on the assumption that the sound masking apparatus 1 emits masker sounds that are mixtures of disturbing sounds and non-disturbing sounds. Alternatively, the sound masking apparatus 1 may emit either disturbing sounds or non-disturbing sounds in the form of masker sounds. Specifically, the reproduction processors 120A_1 to 120A_n and 120B_1 to 120B_n may detect the presence or absence of periodicity in either disturbing sounds or environmental sounds to be emitted in the form of masker sounds, and may add delays responsive to the detection results to the masker sounds. This variation eliminates the need for the mixing controllers 130_1 to 130_n. The sound masking apparatus 1 according to the above embodiment includes a plurality of the output systems. Alternatively, a plurality of the sound masking apparatuses 1 each having a single output system (where N=1) may be installed in an acoustic space, and different delays may be added to masker sounds to be emitted from the sound masking apparatuses 1.

The features of the above-described sound masking apparatus and sound masking method according to the embodiment and variations of the disclosure will be summarized below as respective items [1]-[14].

[1] The present disclosure provides a sound masking apparatus including:

a reproduction processor configured to detect periodicity in a masker sound and add a delay to the masker sound in accordance with a detection result of the periodicity.

[2] In the sound masking apparatus according to item [1], the reproduction processor detects presence or absence of the periodicity in the masker sound, and adds the delay to the masker sound in accordance with a detection result of the presence or the absence of the periodicity.

[3] In the sound masking apparatus according to item [1], the reproduction processor adds the delay to the masker sound by a time length of the delay responsive to a period of the periodicity.

[4] In the sound masking apparatus according to any one of items [1] to [3], further including:

another reproduction processor configured to detect the periodicity in the masker sound and add an another delay, which is different in time length from the delay added by the reproduction processor, to the masker sound in accordance with a detection result of the periodicity.

[5] In the sound masking apparatus according to item [4], the time length of each of the delay and the another delay is an integral multiple of a reference delay time.

[6] In the sound masking apparatus according to any one of items [1] to [5], the masker sound includes a disturbing sound and a non-disturbing sound, and the reproduction processor detects periodicity in the disturbing sound and periodicity in the non-disturbing sound, and adds delays to the disturbing sound and the non-disturbing sound respectively in accordance with detection results of the periodicities.

[7] In the sound masking apparatus according to item [6], the reproduction processor adds a delay to a non-disturbing sound so that a sound waveform peak of the non-disturbing sound to which the delay is added partially overlaps with a sound waveform peak of a non-disturbing sound to which no delay is added.

[8] The present disclosure provides a sound masking method, including:

detecting periodicity in a masker sound; and

adding a delay to the masker sound in accordance with a detection result of the periodicity.

[9] In the sound masking method according to item [8], in the detecting, presence or absence of the periodicity in the masker sound is detected, and in the adding, the delay is added to the masker sound in accordance with a detection result of the presence or the absence of the periodicity.

[10] In the sound masking method according to item [8], in the adding, the delay is added to the masker sound by a time length of the delay responsive to a period of the periodicity.

[11] In the sound masking method according to any one of items [8] to [10], in the adding, different delays are added to masker sounds, a time length of each of the different delays being different every reproduction processors.

[12] In the sound masking method according to item [11], the time length of each of the different delays is an integral multiple of a reference delay time.

[13] In the sound masking method according to any one of items [8] to [12], the masker sound includes a disturbing sound and a non-disturbing sound, and in the detection, periodicity in the disturbing sound and periodicity in the non-disturbing sound are detected, and in the adding, delays are added to the disturbing sound and the non-disturbing sound respectively in accordance with detection results of the periodicities.

[14] In the sound masking method according to item [13], in the adding, a delay is added to a non-disturbing sound so that a sound waveform peak of the non-disturbing sound to which the delay is added partially overlaps with a sound waveform peak of a non-disturbing sound to which no delay is added.

According to the configurations and processes, a delay is added to a masker sound in accordance with the periodicity in the masker sound. This prevents loss of periodicity in a periodic masker sound, and precludes unfavorable additional reverberation of a non-periodic masker sound, resulting in no unpleasant sound. Installing a plurality of such sound masking apparatuses within an acoustic space to carry out sound masking prevents an unbalanced sound pressure distribution of masker sounds within the acoustic space without causing discomfort to a listener.

What is claimed is:

1. A sound masking apparatus, comprising:
a reproduction processor configured to detect periodicity in a masker sound and add a delay to the masker sound in accordance with a detection result of the periodicity.

2. The sound masking apparatus according to claim 1, wherein the reproduction processor detects presence or absence of the periodicity in the masker sound, and adds the delay to the masker sound in accordance with a detection result of the presence or the absence of the periodicity.

3. The sound masking apparatus according to claim 1, wherein the reproduction processor adds the delay to the masker sound by a time length of the delay responsive to a period of the periodicity.

4. The sound masking apparatus according to claim 1, further comprising:
another reproduction processor configured to detect the periodicity in the masker sound and add an another delay, which is different in time length from the delay added by the reproduction processor, to the masker sound in accordance with a detection result of the periodicity.

5. The sound masking apparatus according to claim 4, wherein the time length of each of the delay and the another delay is an integral multiple of a reference delay time.

6. The sound masking apparatus according to claim 1, wherein the masker sound includes a disturbing sound and a non-disturbing sound; and
wherein the reproduction processor detects periodicity in the disturbing sound and periodicity in the non-disturbing sound, and adds delays to the disturbing sound and the non-disturbing sound respectively in accordance with detection results of the periodicities.

7. The sound masking apparatus according to claim 6, wherein the reproduction processor adds a delay to a non-disturbing sound so that a sound waveform peak of the non-disturbing sound to which the delay is added partially overlaps with a sound waveform peak of a non-disturbing sound to which no delay is added.

8. A sound masking method, comprising:
detecting periodicity in a masker sound; and
adding a delay to the masker sound in accordance with a detection result of the periodicity.

9. The sound masking method according to claim 8, wherein in the detecting, presence or absence of the periodicity in the masker sound is detected; and
wherein in the adding, the delay is added to the masker sound in accordance with a detection result of the presence or the absence of the periodicity.

10. The sound masking method according to claim 8, wherein in the adding, the delay is added to the masker sound by a time length of the delay responsive to a period of the periodicity.

11. The sound masking method according to claim 8, wherein in the adding, different delays are added to masker sounds, a time length of each of the different delays being different every reproduction processors.

12. The sound masking method according to claim 11, wherein the time length of each of the different delays is an integral multiple of a reference delay time.

13. The sound masking method according to claim 8, wherein the masker sound includes a disturbing sound and a non-disturbing sound; and
wherein in the detecting, periodicity in the disturbing sound and periodicity in the non-disturbing sound are detected; and
wherein in the adding, delays are added to the disturbing sound and the non-disturbing sound respectively in accordance with detection results of the periodicities.

14. The sound masking method according to claim 13, wherein in the adding, a delay is added to a non-disturbing sound so that a sound waveform peak of the non-disturbing sound to which the delay is added partially overlaps with a sound waveform peak of a non-disturbing sound to which no delay is added.
